(19) United States
(12) Patent Application Publication
(10) Pub. No.: US 2007/0281066 A1
(43) Pub. Date: Dec. 6, 2007

(54) NON-DAIRY BEVERAGE PRODUCT COMPRISING CALCIUM LACTOBIONATE

(76) Inventor: Per Munk Nielsen, Hilleroed (DK)

Correspondence Address: FITCH EVEN TABIN & FLANNERY, 120 S. LASALLE STREET, SUITE 1600, CHICAGO, IL, 60603-3406, US

(21) Appl. No.: 11/574,550

(22) PCT Filed: Sep. 1, 2005
(86) PCT No.: PCT/US05/31211

§ 371 Date: Mar. 1, 2007

(30) Foreign Application Priority Data
Sep. 3, 2004 (DK) PA2004 01337
Sep. 22, 2004 (DK) PA2004 01435

(51) Int. Cl. A23L 1/304; A23L 2/00

(52) U.S. Cl. 426/580

(57) ABSTRACT

The present invention relates to a non-dairy beverage product enriched in calcium with calcium lactobionate.

### TECHNICAL FIELD

The present invention relates to a non-dairy beverage product comprising calcium lactobionate, a method of producing a non-dairy beverage product and use of calcium lactobionate for producing a non-dairy beverage product.

### BACKGROUND OF THE INVENTION

Osteoporosis is a recognised health problem in many areas of the world and is generally ascribed to an insufficient intake of calcium. One of the major sources of calcium in the diet is milk, but a large proportion of the public does not want or does not tolerate sufficient amounts of milk in their diet. To compensate for this, other food products may be enriched with calcium e.g. fruit juice. EP 0841013 describes a method of enriching fruit juice with calcium by addition of calcium phosphate. U.S. Pat. No. 4,722,847 describes a method for supplementation of fruit juice beverages with calcium by using calcium citrate and calcium malate. There is a need for non-dairy beverage products with pleasant taste and mouthfeel that can supply the public with calcium, e.g. in amounts comparable to what can be obtained by consuming milk or other dairy products.

A calcium source derived from milk or milk ingredients may have an advantage over other calcium sources for calcium fortification of non-dairy beverage products since it may be perceived as more natural by the consumer.

WO 02089592 discloses a method for producing dairy products comprising lactobionic acid.

### SUMMARY OF THE INVENTION

The inventors have found that calcium lactobionate may be used for production of a non-dairy beverage product enriched in calcium with a pleasant taste and mouthfeel. The present invention consequently relates to a non-dairy beverage product comprising calcium lactobionate. In a second aspect the invention relates to a method for producing a non-dairy beverage product, and in a further aspect to use of calcium lactobionate for producing a non-dairy beverage product.

### DETAILED DESCRIPTION OF THE INVENTION

Non-Dairy Beverage Product

A non-dairy beverage product is a beverage product which is not based on milk, milk constituents, or milk derived ingredients. By “not based on milk, milk constituents, or milk derived ingredients” is meant that milk, milk constituents, and/or milk derived ingredients, other than calcium lactobionate, does not account for the major part of the product. By milk is meant the lacteal secretion of any mammal and milk products derived there from such as e.g. whole milk, skimmed milk, partially skimmed milk, homogenised milk, and pasteurised milk. By milk constituents is meant any constituent of milk such as e.g. milk protein, milk fat, milk salts, and lactose. By milk derived ingredients are meant any ingredient derived from milk, such as e.g. milk powder, butter milk, butter milk powder, milk fat, butter, whey protein isolate, whey protein concentrate, and caseinate. A non-dairy beverage product according to the invention is not a product consisting only of water and calcium lactobionate, or a product prepared only from water and a calcium lactobionate preparation.

In one embodiment of the invention the non-dairy beverage product comprises less than 30% (weight/weight), such as less than 20%, less than 10%, less than 5% or less than 2%, milk or ingredients derived from milk, other than calcium lactobionate. In another embodiment of the invention the dry matter of the non-dairy beverage product comprises less than 30% (weight/weight), such as less than 20%, less than 10%, less than 5%, or less than 1%, dry matter derived from milk, other than calcium lactobionate. In a further embodiment of the invention a non-dairy beverage product comprises less than 0.4 g/kg, such as less than 0.3 g/kg, less than 0.2 g/kg, less than 0.1 g/kg, or less than 0.01 g/kg, of calcium originating from milk, other than calcium originating from calcium lactobionate. In one embodiment of the invention a non-dairy beverage product does not contain calcium originating from milk other than calcium originating from calcium lactobionate.

A non-dairy beverage product of the invention may e.g. be fruit juice, berry juice, vegetable juice, herbal drink, lemonade, soft drink, soda pop, cola, root beer, beer, smoothie, tea, coffee, or any mixture thereof. A non-dairy beverage product according to the invention may e.g. be based on, or comprise, blended fruit, berries, vegetables, and/or herbs; fruit, berry and/or vegetable juice; fruit, berry, vegetable and/or herbal extracts; and/or fruit, berry, vegetable, and/or herbal flavour. A non-dairy beverage product according to the invention may comprise alcohol, and may e.g. be based on, or comprise, beer or wine.

A non-dairy beverage product of the invention may comprise any ingredient suitable to be used in the preparation of a non-dairy beverage, such as e.g. sugar, e.g. in the form of glucose, fructose, sucrose, invert sugar, or any mixture thereof; sugar alcohols, e.g. xylitol or sorbitol; artificial sweetener, e.g. saccharin, cyclamate, aspartame, acesulfame, sucralose, and/or tagatose; acid, e.g. citric acid; caffeine; flavour agents; colorants; and/or preservatives. A non-dairy beverage product may be carbonated.

A non-dairy beverage product of the invention may additionally comprise thickening or texturising agents, e.g. pectin, carageenan, agar agar, guar gum, or locust bean gum. Calcium lactobionate may in itself have a thickening or texturising effect, and in one embodiment of the invention the amount of thickening and/or texturising agent is reduced compared to a similar beverage product not comprising calcium lactobionate. Calcium lactobionate may improve the mouthfeel and/or viscosity of a non-dairy beverage product compared to the same non-dairy beverage product without calcium lactobionate added, or to the same non-dairy beverage product with a lower molecular weight calcium salt added in an amount giving the same level of added calcium.

In one embodiment of the invention a non-dairy beverage product is fruit, berry, and/or vegetable juice comprising calcium lactobionate.

A non-dairy beverage product comprising calcium lactobionate may be produced by any method known in the art for producing a similar product without calcium lactobionate. Calcium lactobionate may be added to the other ingredients of the product at any appropriate step during the process. Calcium lactobionate may e.g. be added as the purified substance, the preparation obtained by oxidation of lactose in situ in milk permeate, whey, or whey permeate, or in the form of any other preparation suitable for being used in the production of a non-dairy beverage product. Calcium lactobionate may be dissolved in water separately or together with other ingredients of the non-dairy beverage product. Calcium lactobionate may e.g. be added to the product after all other ingredients have been added. If the non-dairy beverage product is fruit, berry, or vegetable juice, calcium lactobionate may e.g. be added to the juice before pasteurisation (if applicable) or before packing of the product. If the non-dairy beverage product is smoothie or another product based on blended fruit, berries, and/or vegetables, calcium lactobionate may e.g. be added to the blended material before pasteurisation (if applicable) or before packing. If the non-dairy beverage product is a carbonated beverage, e.g. soda pop or carbonated cola drink, calcium lactobionate may e.g. be added after or simultaneously with the rest of the ingredients and before carbonation and packing of the product.

Addition of calcium lactobionate may affect pH of the non-dairy beverage product, and if desired pH may be regulated to the desired level by a suitable acid, e.g. citric acid or lactic acid, or base.

Calcium Lactobionate

Calcium lactobionate (C₂₄H₄₂CaO₂₄, CAS no. 5001-51-4) is the calcium salt of lactobionic acid (4-O-beta-D-galactopyranosyl-D-gluconic acid) and has a molecular weight of 756.7 g/mol. Calcium lactobionate according to the invention may be from any source known in the art. In one embodiment of the invention calcium lactobionate is obtained by oxidation of lactose. In a further embodiment calcium lactobionate is obtained by enzymatic oxidation of lactose. Preparation of calcium lactobionate by enzymatic oxidation of lactose may be achieved by enzymes capable of oxidizing lactose to lactobionic acid and neutralisation of the lactobionic acid formed with e.g. calcium hydroxide, calcium carbonate, calcium sulphate, or calcium phosphate to form calcium lactobionate. A suitable enzyme is e.g. the carbohydrate oxidase disclosed in WO 9931990. In one embodiment of the invention the oxidation of lactose is performed in the presence of catalase.

In one embodiment of the invention calcium lactobionate is prepared by enzymatic oxidation of pure lactose, e.g. lactose monohydrate. In another embodiment of the invention calcium lactobionate is prepared by in situ enzymatic oxidation of lactose in milk permeate, whey, or whey permeate. This may be done by adding a suitable enzyme to the milk permeate, whey, or whey permeate under conditions suitable for the enzymatic reaction to proceed, to oxidise the lactose present to lactobionic acid.

Calcium may be added, e.g. as calcium hydroxide to form calcium lactobionate. Addition of calcium may be performed during the enzymatic reaction, e.g. by keeping pH substantially constant by titration with calcium hydroxide, or it may be performed after the enzymatic reaction has run to a desired degree of conversion of lactose. The preparation thus obtained may in addition to the calcium lactobionate contain non-oxidised lactose and other milk constituents such as e.g. salts, minerals, proteins, and/or other small organic molecules. The preparation may be used directly for preparing a non-dairy beverage, or the calcium lactobionate may be purified to remove some or all of the additional constituents. The pH of the calcium lactobionate preparation may be adjusted if desired, to achieve a desired pH of the final beverage product. This may be done by any suitable acid, e.g. citric acid or lactic acid, or base.

When calcium lactobionate is prepared by enzymatic oxidation of lactose a higher degree of conversion of lactose may be achieved if the decrease in pH resulting from the oxidation is completely or partly prevented. A high degree of conversion may be desired e.g. in order to achieve a high amount of calcium lactobionate in the calcium lactobionate preparation and/or in order to control the effect of the calcium lactobionate preparation on the taste of the product. Accordingly, in one embodiment of the invention calcium lactobionate is produced by enzymatic oxidation of lactose wherein calcium hydroxide is added during the oxidation. The addition of calcium hydroxide may e.g. be performed so pH during the oxidation is maintained at a pH above 4, such as above 5, or above 6, or so that pH is maintained between 4 and 8, such as between 5 and 8, or between 6 and 8. The pH value may depend on the non-dairy beverage product to be produced and on the desired pH of the calcium lactobionate preparation. Thus, in one aspect the invention relates to a method for producing a non-dairy beverage product, comprising enzymatically oxidising lactose to lactobionic acid and maintaining pH above 4 during the oxidation by addition of calcium hydroxide. When calcium lactobionate is produced by enzymatic oxidation of lactose a catalase may be present during the oxidation in order to reduce the level of hydrogen peroxide.

By milk permeate is meant the material passing the membrane when milk is subjected to a membrane filtration process, e.g. an ultrafiltration process. Depending on the objective of the membrane filtration process, the pore size of the membrane may be selected so that desired components of the milk are concentrated and smaller components are left in the permeate. Usually fat, whey protein, and casein is concentrated, and lactose and soluble salts/minerals are left in the permeate. Depending on the pore size whey proteins may be present primarily in the concentrate or the permeate, respectively. Ultrafiltration of whey is usually performed to concentrate and remove the whey proteins for other uses, leaving primarily lactose and salts/minerals in the permeate.

The amount of calcium lactobionate may be any amount suitable to achieve a desired level of calcium in the non-dairy beverage. In one embodiment of the invention a non-dairy beverage product comprises at least 0.5% (weight/weight) calcium lactobionate, such as at least 1%, at least 1.5%, or at least 2% calcium lactobionate. In a further embodiment a non-dairy beverage comprises between 0.5 and 10% (weight/weight) lactobionate, such as between 1 and 7%, or between 1.5 and 5% lactobionate. The amount of calcium lactobionate in a non-dairy beverage of the invention may be such as to give a content of calcium comparable to milk. Bovine milk normally contains about 1.0-1.3 g/kg calcium. The corresponding amount of calcium lactobionate is about 2.0-2.5% (weight/weight).

A calcium lactobinate preparation is a calcium lactobionate product consisting of calcium lactobionate and optionally additional components originating from the raw materials used to produce the calcium lactobionate which have not been removed by purification of the calcium lactobionate, e.g. milk constituents originating from milk, milk permeate, whey, or whey permeate.

In one embodiment a liquid calcium lactobionate preparation of the invention is filtered to remove impurities, e.g. in order to remove impurities that may impart a cloudy appearance to the non-dairy beverage product. Filtering may be performed before the calcium lactobionate preparation is mixed with other ingredients, or a mixture of calcium lactobionate preparation and some or all of the additional ingredients of the non-dairy beverage product may be filtered.

### EXAMPLES

### Example 1

### Materials

Calcium lactobionate preparation prepared from milk permeate by enzymatic oxidation of lactose and with pH kept in the range 5.8-6.4 by addition of calcium hydroxide. The preparation contained 80% calcium lactobionate.
Orange juice “Foodline” (SuperGros A/S, Denmark).
Apple juice “Foodline” (SuperGros A/S, Denmark)
Smoothie (Rynkeby Foods A/S, Denmark) blended fruit and fruit juices from 7 kinds of fruits.

1.48 g of calcium lactobionate preparation was added to 50 g of juice or smoothie, respectively, and the mixture was stirred for 15 minutes. pH was measured before and after addition of calcium lactobionate, the results are shown in table 1.

TABLE 1

| | pH before addition of | pH after addition of |
|---|---|---|
| Product | calcium lactobionate | calcium lactobionate |
| Orange juice | 3.85 | 4.04 |
| Apple juice | 3.83 | 4.38 |
| Smoothie | 3.88 | 4.21 |

The products were tasted and compared to the same products without addition of calcium lactobionate. All products had a pleasant taste, and tasted slightly sweeter and with a more soft taste compared to the products without addition of calcium lactobionate. The appearance of the orange juice and the smoothie was not affected by addition of calcium lactobionate. The apple juice became cloudy when calcium lactobionate was added. This should probably be ascribed to the raw materials used for preparing the calcium lactobionate, since a solution of the calcium lactobionate preparation in water had a similar cloudy appearance.

### Example 2

### Materials

Calcium lactobionate (C₂₄H₄₂CaO₂₄.2H₂O, Fluka) purity >98%
Coca Cola (Coca Cola Danmark, Denmark)

3.56 g calcium lactobionate was dissolved in water to a total volume of 10 ml. 1.67 ml of the resuiting solution was added to one 50 ml sample of Coca Cola and 3.33 ml of the solution was added to another 50 ml sample of Coca Cola. Both samples were stable and did not show any sign of sedimentation and had unaltered visual appearance. The taste of the samples with added calcium lactobionate was very similar to that of Coca Cola without calcium lactobionate. pH of Coca Cola was 2.35 before addition of calcium lactobionate and 4.20 in the sample with 3.33 ml calcium lactobionate solution added.

### Example 3

Two types of low calorie drink were prepared from drink concentrate from the local supermarket by mixing the concentrate with water in the ratio prescribed by the producer:

a) 1:11 blackcurrant light, Pebas A/S (Denmark), low calorie fruit drink concentrate

b) 1+11 X-tra orange, Coop Norden (Denmark), low calorie fruit drink concentrate

Calcium lactobionate (Ca-LBA) products were added to the beverages corresponding to 0.12% Calcium. The Ca-LBA was made from either whey permeate powder or lactose monohydrate powder in the following way:

1. The permeate or lactose monohydrate powder was solubilised in water in a concentration of 5% lactose in the water.

2. pH was adjusted to 6.4, temperature to 49° C. Air was blown into the mixture and distributed by efficient stirring.

3. Enzyme composition consisting of lactose oxidase and catalase was added in dosage corresponding to 1 LOXU/g lactose and 6 mg/g lactose for lactose oxidase and catalase, respectively.

4. pH was kept constant during the whole reaction period by addition of a 2 N calcium hydroxide suspension.

5. Reaction was carried out until all the lactose was converted to lactobionate.

Results

The Ca-LBA added products were evaluated in comparison to reference samples without addition of Ca-LBA. The results are described in table 2.

TABLE 2

| | | Mixed with | Mixed with Ca-LBA |
|---|---|---|---|
| | Mixed with water | Ca-LBA made from | made from whey per- |
| | (Reference) | lactose | meate |
| 1:11 Blackcurrant light | A somewhat sharp | Slightly sweeter, with | |
| Pebas A/S | taste | a good mouthfeel | |
| | pH 3.46 | Somewhat cloudy | |
| | Clear solution | pH 4.08 | |
| 1 + 11 X-tra Orange, | A somewhat sharp | Slightly sweeter, with | A “softer” mouthfeel, |
| Coop Norden | taste | a good mouthfeel | Taste as reference |
| | pH 3.12 | Somewhat cloudy | |
| | Almost clear solution | pH 3.79 | |

1. A non-dairy beverage product comprising calcium lactobionate.

2. The beverage product of claim 1 comprising less than 30% (weight/weight) milk and/or ingredients derived from milk, other than calcium lactobionate.

3. The beverage product of claim 1 comprising less than 0.4 g/kg calcium originating from milk, other than calcium originating from calcium lactobionate.

4. The beverage product of claim 1, wherein the calcium lactobionate is produced by oxidation of lactose.

5. The beverage product of claim 4, wherein the calcium lactobionate is produced by enzymatic oxidation of lactose.

6. The beverage product of claim 4, wherein the lactose is derived from milk.

7. The beverage product of claim 5, wherein the calcium lactobionate is produced from milk permeate, whey and/or whey permeate by in situ oxidation of the lactose in the milk permeate, whey and/or whey permeate, and addition of calcium hydroxide.

8. The beverage product of claim 1 comprising calcium lactobionate in an amount of at least 0.5% (weight/weight).

9. The beverage product of claim 1 comprising calcium lactobionate in an amount of between 0.5% and 10% (weight/weight).

10. A method for producing a non-dairy beverage product comprising mixing calcium lactobionate with additional ingredients suitable for producing the non-dairy beverage.

11. A method for producing a non-dairy beverage product, comprising enzymatically oxidising lactose to lactobionic acid and maintaining pH above 4 during the oxidation by addition of calcium hydroxide.

12. (canceled)

13. The beverage product of claim 5, wherein the lactose is derived from milk.
